(19) United States
(12) Patent Application Publication
(10) Pub. No.: US 2007/0296774 A1
(43) Pub. Date: Dec. 27, 2007

(54) Ink supplying apparatus and image forming device having the same

(75) Inventors: In-su Lee, Suwon-si (KR); Young-su Lee, Yongin-si (KR); Myoung-song Jung, Gunpo-si (KR); Tae-kyun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/634,273

(22) Filed: Dec. 6, 2006

(30) Foreign Application Priority Data
Jun. 23, 2006 (KR) 2006-57073

(51) Int. Cl. B41J 2/175

(52) U.S. Cl. 347/85

(57) ABSTRACT

An ink supplying apparatus of an image forming device including an ink discharging unit to discharge ink of an ink cartridge, a needle connected to the ink discharging unit to form an ink supplying passage, a blocking unit to block the needle from being exposed to the outside, and a sealing member to seal the ink discharging unit and the blocking unit. Accordingly, the apparatus can not only block the needle from being exposed to the outside, but can also prevent an ink leakage, thereby facilitating a safer use of the image forming device to safely use.

### CROSS-REFERENCE TO RELATED APPLICATION

This application claims the benefit under 35 U.S.C. § 119(a) of Korean Patent Application No. 2006-57073, filed Jun. 23, 2006, in the Korean Intellectual Property Office, the entire disclosure of which is hereby incorporated by reference.

### BACKGROUND OF THE INVENTION

1. Field of the Invention

Aspects of the present invention generally relate to an image forming device, and more particularly, to an ink supplying apparatus that ejects ink to form an image, and an image forming device having the ink supplying apparatus.

2. Description of the Related Art

Generally, an image forming device (such as an inkjet printer) is provided with a print head to eject ink to form a desired image, and an ink supplying apparatus to supply the ink to the print head. FIG. 1 is a cross sectional view schematically exemplifying an ink supplying apparatus of a general image forming device.

As illustrated in FIG. 1, the ink supplying apparatus of the general image forming device includes an ink chamber 10 and a needle assembly 20 combined with the ink chamber 10 to form an ink supplying passage to a print head (not illustrated). The ink chamber 10 has at least one ink discharging unit 11. The needle assembly 20 has at least one needle 21 that can connect to the ink discharging unit 11. As illustrated in FIGS. 2A and 2B, each of the three needles 21 is provided with an ink supplying hole 21a and the needle 21 has a pointed end.

When the ink chamber 10 is combined with the needle assembly 20, the pointed end of the needle 21 connects to the ink discharging unit 11 of the ink chamber 10, thus penetrating the ink discharging unit 11. Accordingly, ink in the ink chamber 10 flows into the needle 21 through the ink supplying hole 21 a so that the ink can be supplied to the print head and ejected onto a print medium, such as paper.

However, the ink supplying apparatus of the conventional image forming device as described above is provided so that when the ink chamber 10 and the needle assembly 20 are separated from each other, the needle 21 of the needle assembly 20 is exposed to the outside. Accordingly, the conventional ink supplying apparatus may present a problem in that ink leaks through the ink supplying hole 21 a of the needle 21 and foreign substances flow into the needle 21 through the ink supplying hole 21a.

Also, when replacing the ink chamber 10, the ink chamber 10 may be damaged by the needle 21 so that the ink is leaks and/or external air is taken in. This problem particularly occurs when the needle 21 is inserted into the ink chamber 10 and the needle assembly 20 is not correctly connected to the ink chamber 10.

### SUMMARY OF THE INVENTION

Aspects of the present invention address at least the above problems and/or disadvantages and provide at least the advantages described below. Accordingly, aspects of the present invention provide an ink supplying apparatus and an image forming device having the same, which can block an ink leakage and an inflow of external foreign substances, thus allowing the image forming device to be safely and efficiently used.

According to an aspect of the present invention, there is provided an ink supplying apparatus including an ink discharging unit to discharge ink of an ink cartridge, a needle connected to the ink discharging unit to form an ink supplying passage, a blocking unit to block the needle from being exposed to the outside, and a sealing member to seal between the ink discharging unit and the blocking unit.

According to an aspect of the present invention, the blocking unit may be movable up and down around the needle, so that the blocking unit blocks the needle separated from the ink discharging unit from being exposed to the outside.

According to an aspect of the present invention, the blocking unit may be configured so that it is pressed in one direction by the ink discharging unit when the ink discharging unit and the needle are connected to each other.

According to an aspect of the present invention, the blocking unit may include a blocking member to contain the needle therein, and a guide to guide a movement of the blocking member.

According to an aspect of the present invention, the guide may include a blocking member holder to support the blocking member, an elastic member to elastically urge the blocking member holder in the other direction, and a housing to support the blocking member, the blocking member holder and the elastic member and to restrict a movement range of the blocking member holder.

According to an aspect of the present invention, the ink discharging unit may have a cap provided thereon.

According to an aspect of the present invention, the cap may include an inserting member through which the needle is penetratingly inserted, and an inserting member holder to support the inserting member.

According to an aspect of the present invention, the sealing member may include an annular ring member projected from the cap or the blocking unit.

According to another aspect of the present invention,, the sealing member may include at least one first sealing member provided on the blocking unit, and at least one second sealing member provided on the cap.

According to another aspect of the present invention, the first and the second sealing members may include a groove and a protrusion, which are positioned opposite to each other, respectively.

According to yet another aspect of the present invention, there is provided an image forming device including a replaceable ink cartridge having a cap, a needle combined with the ink cartridge penetrating the cap so that the needle forms an ink supplying passage, a print head to eject ink supplied from the needle onto a print medium, a blocking unit to block the needle from being exposed to the outside when the needle is not combined with the ink cartridge, and a sealing member to seal between the cap and the blocking unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross sectional view schematically exemplifying an ink supplying apparatus of a conventional image forming device;

FIGS. 2A and 2B are a front view and a side elevation view exemplifying a needle of the ink supplying apparatus of FIG. 1;

FIG. 3 is an exploded perspective view schematically exemplifying an ink supplying apparatus of an image forming device according to an embodiment of the present invention;

FIG. 4 is a perspective view exemplifying the ink supplying apparatus of FIG. 3 in which an ink cartridge and a needle are combined with each other;

FIG. 5 is a partial perspective view exemplifying an example of a blocking member of the ink supplying apparatus in accordance with the exemplary embodiment of the present invention; and

FIGS. 6 and 7 are views schematically exemplifying examples of a sealing member of the ink supplying apparatus according to an embodiment of the present invention.

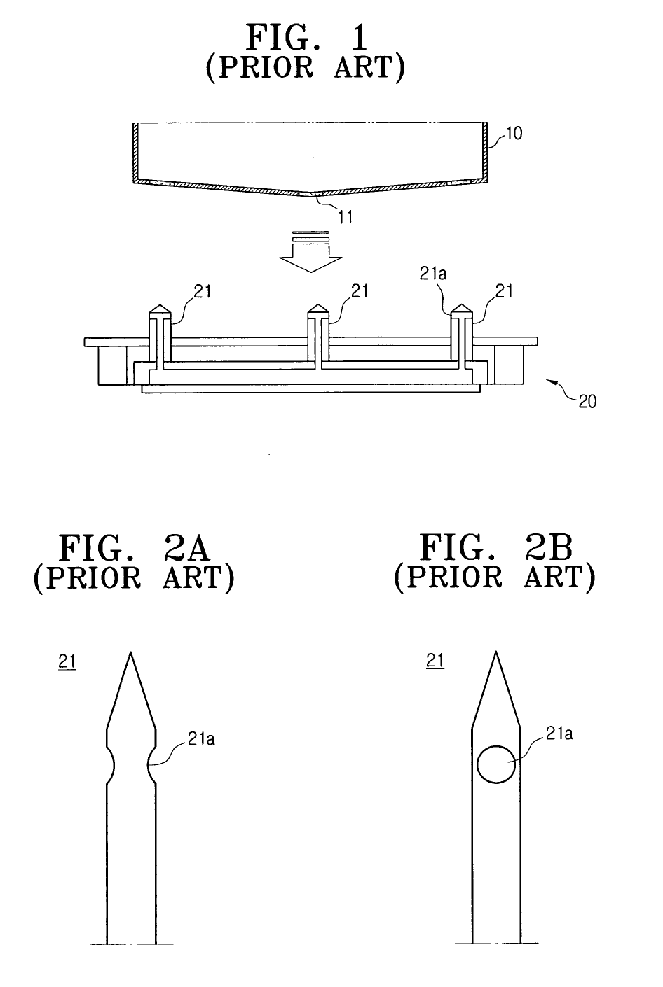

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

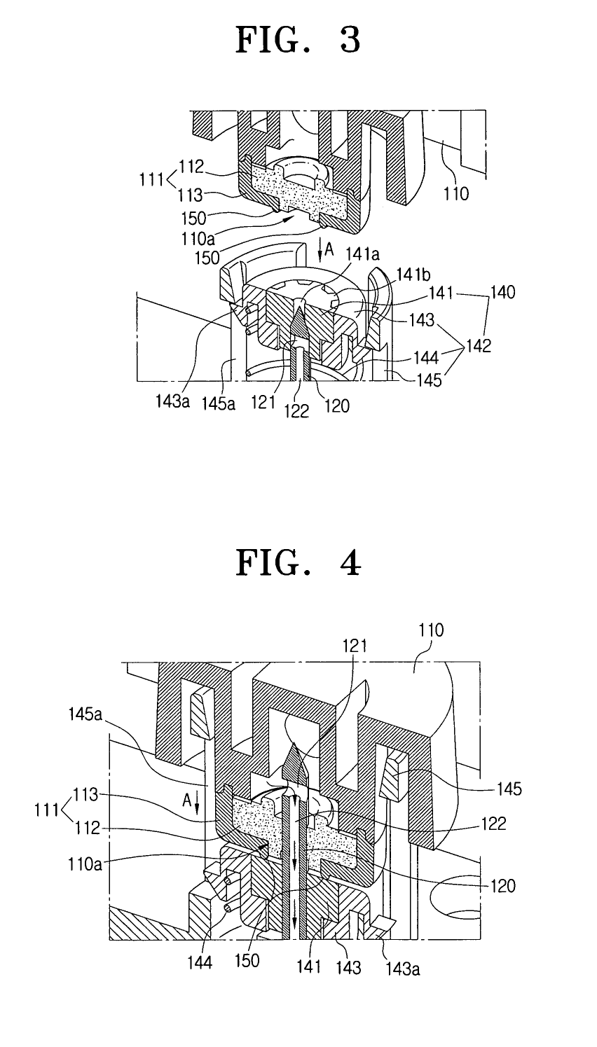

As illustrated in FIGS. 3 and 4, an image forming device according to an embodiment of the present invention includes an ink cartridge 110, a needle 120, a print head (not illustrated), a blocking unit 140, and a sealing member 150. The image forming device may be, for example, a printer, a fax machine, or a multifunction peripheral.

The ink cartridge 110 contains ink therein, and is replaceable with a new cartridge 110 when the ink is used up. To realize printing images of various colors, the ink cartridge 110 may be embodied in a plurality of ink cartridges, which are not illustrated. The ink cartridge 110 includes an ink discharging unit 110a on which a cap 111 is provided thereon. The cap 111 includes an inserting member 112 through which the needle 120 is penetratingly inserted, and an inserting member holder 113 to support the inserting member 112.

The inserting member 112 is formed of a material (such as but not limited to rubber) through which the needle 120 can penetrate. When the needle 120 is not inserted into the inserting member 112, the inserting member 112 blocks the ink in the ink cartridge 110 from being leaked to the outside.

The inserting member holder 113 functions to fix the inserting member 112 to the ink discharging unit 110a of the ink cartridge 110, so that the inserting member 112 is not distorted or displaced due to the insertion of the needle 120.

The ink discharging unit 110a is included in an ink supplying apparatus of the image forming device, together with the needle 120, the blocking unit 140, and the sealing member 150, which will be described in detail below.

The needle 120 connects to the ink cartridge 110 by penetrating the inserting member 112 of the cap 111 so that it forms an ink supplying passage 122. The needle 120 has a pointed end, as illustrated in the drawings. Also the needle 120 includes an ink supplying hole 121, which is inserted into the ink cartridge 110 to take in the ink. Accordingly, when the pointed end of the needle 120 is inserted into the ink cartridge 110, penetrating the inserting member 112, the ink in the ink cartridge 110 flows into the needle 120 through the ink supplying hole 121 so that it can be supplied to the print head and ejected onto a print medium, such as paper.

The print head, which is not illustrated, ejects the ink supplied through the needle 120 onto the print medium to form a desired image thereon. Since image forming operations and principles of the print head are the same as those of the conventional print head known in the art, detailed descriptions and illustrations thereof will be omitted for clarity and conciseness.

The blocking unit 140 blocks the needle 120 (more particularly, the ink supplying hole 121) from being exposed to the outside when the needle 120 is not connected to the ink cartridge 110. The blocking unit 140 may be movable, in an up and down direction, around the needle 120 when the needle 120 is separated from the ink discharging unit 110a. It is understood that the blocking unit 140 is movable in a direction parallel to the direction that the needle 120 connects to the ink cartridge 110, which is not necessarily an up and down direction. To be more specific, the blocking unit 140 is pressed and lowered in a connecting direction (a direction of arrow A illustrated in the drawings) by a pressing force of the ink discharging unit 110a when the ink discharging unit 110a and the needle 120 are connected to each other. The blocking unit 140 is raised and returned to an original position when the pressing force of the ink discharging unit 110a is removed. For this, the blocking unit 140 includes a blocking member 141 and a guide 142.

The blocking member 141 surrounds the needle 120 to block the ink supplying hole 121 from being exposed to the outside, and has a receiving hole 141a formed located approximately in a center thereof to accommodate the needle 120. The receiving hole 141a is provided along a direction that the needle 120 is inserted into the inserting member 112 so that it does not obstruct an inserting force of the needle 120. When the blocking member 141 is pressed in the connecting direction (the direction of arrow A) by the cap 111 of the ink discharging unit 110a, the needle 120 located in the receiving hole 141a penetrates the inserting member 112 while escaping from the blocking member 141.

The blocking member 141 may be formed of an elastic material, such as a rubber, like the inserting member 112, so that the blocking member 141 and the needle 120 are maintained in close contact with each other. Also, a plurality of supporting protrusions 141b may be provided on an outer circumferential surface of the blocking member 141, thus compensating for a deformation of the blocking member 141 due to material characteristics. While described as being made of an elastic material, it is understood that the member 141 can be made movable by a combination of nonelastic and biasing mechanisms, such as a spring attached to a plate.

The guide 142 guides a movement of the blocking member 141, and includes a blocking member holder 143, an elastic member 144, and a housing 145. The blocking member holder 143 supports the blocking member 141, which moves up and down, according to an aspect, and guides a position movement of the blocking member 141.

The elastic member 144 elastically pressures the blocking member holder 143 in the other direction, that is, an opposite direction to the connecting direction (the direction of arrow A) that the blocking member 141 is pressed by the ink discharging unit 110a. Accordingly, after the ink discharging unit 110a and the needle 120 are combined with each other as the blocking member 141 is pressed in the connecting direction (the direction of arrow A) by the ink cartridge 110, when the combination between the ink discharging unit 110a and the needle 120 is released, the blocking member 141 is returned to the original position by the elastic member 144. Thus, when the ink discharging unit 110a and the needle 120 are combined with each other, or released or separated from each other, the ink supplying hole 121 of the needle 120 is surrounded by the blocking member 141 so that it is not exposed to the outside. The elastic member 144 may be made of a general compression coil spring.

The housing 145 supports the blocking member 141, the blocking member holder 143, and the elastic member 144. Also, the housing 145 may include a guide hole 145a, which restricts a moving range of the blocking member holder 143 by the combination between the ink cartridge 110 and the needle 120. A guide protrusion 143a, which is inserted into the guide hole 145, is projected corresponding to the guide hole 145a from the blocking member holder 143.

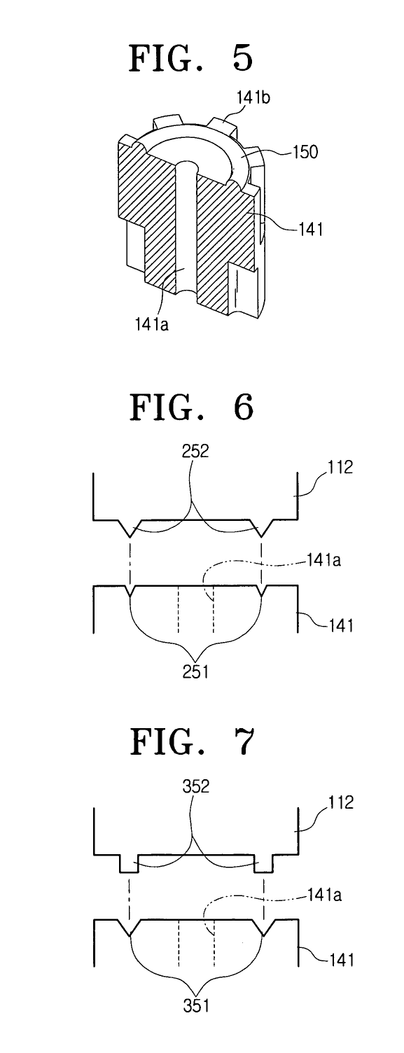

The sealing member 150 prevents the ink from being leaked at a contact point between the cap 111 of the ink discharging unit 110a and the blocking unit 140, and is formed of an annular ring member projected from the inserting member holder 113. Here, the installed position of the sealing member 150 is not limited to only the inserting member holder 113. For instance, as illustrated in FIG. 5, the sealing member 150 can be formed to project from the blocking member 141 rather than the inserting member holder 113. Also, the sealing member 150 can be modified in other configurations, according to other aspects of the present invention. For example, the sealing member 150 can be made of a first sealing member 251 and a second sealing members 252 formed at portions of the blocking member 141 and the inserting member 112, which are positioned opposite to each other, respectively, as illustrated in FIG. 6. However, it is understood that the first sealing member 251 may be provided on the inserting member 112 and the second sealing member 252 may be provided on the blocking member 141.

In this case, the first sealing members 251 may be formed of a triangle-shaped groove, and the second sealing member 252 may be formed of a triangle-shaped protrusion, which is inserted into the triangle-shaped groove. To prevent the blocking member 141 and the cap 111 from coming in surface contact with each other, thus improving a sealing efficiency, the triangle-shaped groove of the first sealing members 251 may be formed smaller than the triangle-shaped protrusion of the second sealing member 252.

FIG. 7 illustrates another example of the sealing member 150. In this case, the sealing member 150 is made of a first sealing member 351, which is a triangle-shaped groove formed on the blocking member 141, and a second sealing members 352, which is a quadrangle-shaped protrusion inserted into the triangle-shaped groove.

The sealing member 150, as described above, is not limited to the illustrated examples, but can be modified in other various technical constructions. For instance, a first and a second sealing members (not illustrated) of the sealing member 150 can be formed to project from the blocking member 141 and the inserting member 112, respectively, or a sealing member (not illustrated) can be formed on the blocking member holder 143 and/or the inserting member holder 113. At this time, a shape of the sealing member also can be configured to have other shapes other than the triangle and the quadrangle illustrated, such as a circle.

Hereinafter, an ink supplying operation of the image forming device having the ink supplying apparatus constructed as described above will now be described with reference to FIGS. 3 and 4. As illustrated in FIG. 3, when the needle 120 is inserted into the ink cartridge 110 in the connecting direction (a direction of arrow A), the blocking unit 140 is pressed and moved in the direction of arrow A by the ink discharging unit 110a of the ink cartridge 110. It is understood that to connect the needle 120 and the ink cartridge 110, the needle 120 may move toward the ink cartridge 110 in a direction opposite the direction of arrow A and/or the ink cartridge 110 may move toward the needle 120 in the direction of arrow A. At this time, the guide protrusion 143a of the blocking member holder 143 is guided along the guide hole 145a of the housing 145, and the elastic member 144 is compressed by a pressing force of the ink discharging unit 110a.

As the blocking unit 140 is pressed in the direction of arrow A, as described above, the needle 120 located in the receiving hole 141 a of the blocking member 141 gradually escapes from the blocking member 141, and, at the same time, inserts into the inserting member 112 by penetrating the inserting member 112. Accordingly, the needle 120 is not exposed to the outside, but inserted into the ink cartridge 110. As a result, the ink is supplied to the print head.

At this time, even though the supplied ink may leak between the inserting member 112 and the needle 120, it does not leak through to the outside since the sealing member 150 is disposed between the ink cartridge 110 and the blocking unit 140.

As is apparent from the foregoing description, according to aspects of the present invention, the ink supplying apparatus and the image forming apparatus having the same includes the blocking unit 140 to block the needle 120 , which is combined with the ink cartridge 110 to form the ink supplying passage 122, from being exposed to the outside. Accordingly, the ink supplying apparatus and the image forming apparatus having the same, according to aspects of the present invention, can address the problems, such as ink leakage and inflow of external foreign substances, which arise as a result of the exposure of the needle to the outside.

Also, according to aspects of the present invention, the ink supplying apparatus, and the image forming apparatus having the same, includes the sealing member 150 to seal the ink cartridge and the blocking unit. Accordingly, the ink supplying apparatus and the image forming apparatus having the same, according to aspects of the present invention, can prevent ink leakage even though the ink cartridge and the print head are not correctly installed and/or connected to each other. Thus, product quality can be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is

1. An ink supplying apparatus comprising:
an ink discharging unit to discharge ink of an ink cartridge;
a needle to form an ink supplying passage when connected to the ink discharging unit;
a needle assembly comprising the needle;
a blocking unit to block the needle from being exposed to an outside area of the needle assembly when the needle and the ink discharging unit are not connected; and
a sealing member to seal between the ink discharging unit and the blocking unit such that the sealing member prevents the ink from leaking outside the ink discharging unit when the ink flows through the ink supplying passage.

2. The ink supplying apparatus as claimed in claim 1, wherein the needle and the ink discharging unit connect to each other in a connecting direction, the blocking unit is movable in a direction parallel to the connecting direction, and the blocking unit moves around the needle, so that the blocking unit blocks the needle from being exposed to the outside area of the needle assembly when the blocking unit is not connected to the ink discharging unit.

3. The ink supplying apparatus as claimed in claim 2, wherein the blocking unit is pressed in a pressing direction, opposite to a movement of the needle assembly and/or similar to a movement of the ink discharging unit, by the ink discharging unit when the needle and the ink discharging unit connect to each other.

4. The ink supplying apparatus as claimed in claim 3, wherein the blocking unit comprises:
a blocking member to contain the needle therein; and
a guide to guide a movement of the blocking member.

5. The ink supplying apparatus as claimed in claim 4, wherein the guide comprises:
a blocking member holder to support the blocking member;
an elastic member to pressure the blocking member holder in a direction opposite to the pressing direction; and
a housing to support the blocking member, the blocking member holder, and the elastic member.

6. The ink supplying apparatus as claimed in claim 5, wherein:
the blocking member holder comprises a protrusion; and
the guide comprises a guide hole, through which the protrusion fits, to restrict a movement of the blocking member holder by restricting a movement of the protrusion.

7. The ink supplying apparatus as claimed in claim 1, wherein the ink discharging unit comprises a cap to block the ink from leaking to an outside of the ink discharging unit.

8. The ink supplying apparatus as claimed in claim 7, wherein the cap comprises:
an inserting member; and
an inserting member holder to support the inserting member, and the needle connects to the ink discharging unit by penetrating the inserting member.

9. The ink supplying apparatus as claimed in claim 7, wherein the sealing member comprises an annular ring member projected from the cap and/or the blocking unit.

10. The ink supplying apparatus as claimed in claim 7, wherein the sealing member comprises:
at least one first sealing member provided on a surface of the blocking unit; and
at least one second sealing member provided on a surface of the cap.

11. The ink supplying apparatus as claimed in claim 10, wherein
the at least one first sealing member comprises at least one groove,
the at least one second sealing member comprises at least one protrusion, and
the at least one first sealing member is positioned opposite to the at least one second sealing member such that when the needle is connected to the ink discharging unit, the at least one protrusion fits into a corresponding groove of the at least one groove.

12. The ink supplying apparatus as claimed in claim 10, wherein
the at least one second sealing member comprises at least one groove,
the at least one first sealing member comprises at least one protrusion, and
the at least one second sealing member is positioned opposite to the at least one first sealing member such that when the needle is connected to the ink discharging unit, the at least one protrusion fits into a corresponding groove of the at least one groove.

13. An image forming device comprising:
a replaceable ink cartridge comprising a cap to block ink from leaking outside of the ink cartridge;
a needle to form an ink supplying passage when connected to the ink cartridge;
a print head to eject the ink supplied from the needle through the ink supplying passage onto a print medium;
a needle assembly comprising the needle;
a blocking unit to block the needle from being exposed to an outside area of the needle assembly when the needle and the ink cartridge are not connected; and
a sealing member to seal between the cap and the blocking unit such that the sealing member prevents the ink from leaking outside the ink cartridge when the ink flows through the ink supplying passage,
wherein the needle connects to the ink cartridge by penetrating the cap.

14. The image forming device as claimed in claim 13, wherein
the needle and the ink cartridge connect to each other in a connecting direction,
the blocking unit comprises:
a blocking member to contain the needle therein and to move around the needle;
and
a guide to guide a movement of the blocking member, and
the blocking member moves in a direction parallel to the connecting direction and the blocking member is pressed in a pressing direction, opposite to a movement of the needle assembly and/or similar to a movement of the ink cartridge, by the ink cartridge when the needle and the ink cartridge connect to each other.

15. The image forming device as claimed in claim 14, wherein the guide comprises:
a blocking member holder to support the blocking member;
an elastic member to pressure the blocking member holder in a direction opposite to the pressing direction; and
a housing to support the blocking member, the blocking member holder, and the elastic member.

16. The image forming device as claimed in claim 15, wherein:
the blocking member holder comprises a protrusion; and
the guide comprises a guide hole, through which the protrusion fits, to restrict a movement of the blocking member holder by restricting a movement of the protrusion.

17. The image forming device as claimed in claim 13, wherein
the cap comprises:
an inserting member; and
an inserting member holder to support the inserting member, and
the needle connects to the ink cartridge by penetrating the inserting member.

18. The image forming device as claimed in claim 13, wherein the sealing member comprises an annular ring member projected from the cap and/or the blocking unit.

19. The image forming device as claimed in claim 13, wherein the sealing member comprises:
at least one first sealing member provided on a surface of the blocking unit; and
at least one second sealing member provided on a surface of the cap.

20. The image forming device as claimed in claim 19, wherein
the at least one first sealing member comprises at least one groove,
the at least one second sealing member comprises at least one protrusion, and
the at least one first sealing member is positioned opposite to the at least one second sealing member such that when the needle is connected to the ink cartridge, the at least one protrusion fits into a corresponding groove of the at least one groove.

21. The image forming device as claimed in claim 19, wherein
the at least one second sealing member comprises at least one groove,
the at least one first sealing member comprises at least one protrusion, and
the at least one second sealing member is positioned opposite to the at least one first sealing member such that when the needle is connected to the ink cartridge, the at least one protrusion fits into a corresponding groove of the at least one groove.

22. An ink supplying apparatus comprising:
an ink discharging unit comprising a cap to block ink from leaking outside of the ink cartridge;
a needle to form an ink supplying passage when connected to the ink discharging unit;
a needle assembly comprising the needle; and
a blocking unit to block the needle from being exposed to an outside area of the needle assembly when the needle and the ink discharging unit are not connected.

23. The ink supplying apparatus as claimed in claim 22, wherein
the needle and the ink discharging unit connect to each other in a connecting direction, and
the blocking unit is movable in a direction parallel to the connecting direction and the blocking unit moves around the needle, so that the blocking unit blocks the needle from being exposed to the outside area of the needle assembly when the blocking unit is not connected to the ink discharging unit.

24. The ink supplying apparatus as claimed in claim 23, wherein the blocking unit is pressed in a pressing direction, opposite to a movement of the needle assembly and/or similar to a movement of the ink discharging unit, by the ink discharging unit when the needle and the ink discharging unit connect to each other.

25. The ink supplying apparatus as claimed in claim 24, wherein the blocking unit comprises:
a blocking member to contain the needle therein; and
a guide to guide a movement of the blocking member.

26. The ink supplying apparatus as claimed in claim 25, wherein the guide comprises:
a blocking member holder to support the blocking member;
an elastic member to pressure the blocking member holder in a direction opposite to the pressing direction; and
a housing to support the blocking member, the blocking member holder, and the elastic member.

27. The ink supplying apparatus as claimed in claim 26, wherein:
the blocking member holder comprises a protrusion; and
the guide comprises a guide hole, through which the protrusion fits, to restrict a movement of the blocking member holder by restricting a movement of the protrusion.

28. The ink supplying apparatus as claimed in claim 22, wherein the cap comprises:
an inserting member; and
an inserting member holder to support the inserting member, and the needle connects to the ink discharging unit by penetrating the inserting member.

29. The ink supplying apparatus as claimed in claim 22, further comprising:
a sealing member to seal between the ink discharging unit and the blocking unit such that the sealing member prevents the ink from leaking outside the ink discharging unit when the ink flows through the ink supplying passage.

30. An ink supplying apparatus comprising:
an ink discharging unit comprising a cap to block ink from leaking to an outside of the ink cartridge;
a needle to form an ink supplying passage when connected to the ink discharging unit;
a needle assembly comprising the needle; and
a sealing member to seal between the ink discharging unit and the needle assembly such that the sealing member prevents the ink from leaking outside the ink discharging unit when the ink flows through the ink supplying passage.

31. The ink supplying apparatus as claimed in claim 30, further comprising:
a blocking unit to block the needle from being exposed to an outside area of the needle assembly when the needle and the ink discharging unit are not connected.

32. The ink supplying apparatus as claimed in claim 30, wherein the sealing member comprises an annular ring member projected from the cap and/or the needle assembly.

33. The ink supplying apparatus as claimed in claim 30, wherein the sealing member comprises:
at least one first sealing member provided on a surface of the needle assembly; and
at least one second sealing member provided on a surface of the cap.

34. The ink supplying apparatus as claimed in claim 33, wherein
the at least one first sealing member comprises at least one groove,
the at least one second sealing member comprises at least one protrusion, and
the at least one first sealing member is positioned opposite to the at least one second sealing member such that when the needle is connected to the ink discharging unit, the at least one protrusion fits into a corresponding groove of the at least one groove.

35. The ink supplying apparatus as claimed in claim 33, wherein
the at least one second sealing member comprises at least one groove,
the at least one first sealing member comprises at least one protrusion, and
the at least one second sealing member is positioned opposite to the at least one first sealing member such that when the needle is connected to the ink discharging unit, the at least one protrusion fits into a corresponding groove of the at least one groove.

36. A method of supplying ink to a needle that connects to an ink discharging unit of an image forming apparatus, the method comprising:
connecting the needle to the ink discharging unit by moving a blocking unit in a first direction to release the needle from therewithin while the needle penetratingly inserts into the ink discharging unit; separating the needle from the ink discharging unit; and
protecting the needle by moving the blocking unit, to surround the needle, in a second direction opposite to the first direction while the needle separates from the ink discharging unit.

37. The method as claimed in claim 36, wherein the connecting of the needle comprises pressing the blocking unit, with the ink discharging unit, in the first direction.

38. The method as claimed in claim 37, further comprising pressuring the blocking unit elastically in the second direction.
